(19) United States
(12) Patent Application Publication
(10) Pub. No.: US 2008/0025247 A1
(43) Pub. Date: Jan. 31, 2008

(54) INDICATING SPECIAL TRANSMISSIONS IN WIRELESS COMMUNICATION SYSTEMS

(75) Inventors: Sean M. McBeath, Keller, TX (US); Hao Bi, Lake Zurich, IL (US); James M. O'Connor, Dallas, TX (US); Danny T. Pinckley, Arlington, TX (US); John D. Reed, Arlington, TX (US); Jack A. Smith, Valley View, TX (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/668,004

(22) Filed: Jan. 29, 2007

Related U.S. Application Data
(60) Provisional application No. 60/820,673, filed on Jul. 28, 2006.

(51) Int. Cl. H04B 7/212

(52) U.S. Cl. 370/321

(57) ABSTRACT

A wireless communication infrastructure entity assigns a plurality of schedulable wireless communication entities to a group wherein each entity is assigned a location within the group. The infrastructure entity indicates which of the plurality of schedulable wireless communication entities assigned to the group have been assigned a wireless resource, for example using a terminal assignments field (910) and indicates special transmission information using a special transmissions field (905). The special transmissions field (905) is used to indicate which of the schedulable wireless communication entities are receiving a special transmission.

### REFERENCE TO RELATED APPLICATION

The present application claims priority from provisional application Ser. No. 60/820,673, entitled “INDICATING SPECIAL TRANSMISSIONS IN WIRELESS COMMUNICATION SYSTEMS,” filed Jul. 28, 2006, which is commonly owned and incorporated herein by reference in its entirety.

### FIELD OF THE DISCLOSURE

The present disclosure relates generally to wireless communications and more particularly to indicating special transmissions to a group of wireless communications terminals sharing a set of time-frequency resources.

### BACKGROUND OF THE DISCLOSURE

In some data only (DO) wireless communications systems, voice is served over a voice-over-internet protocol (VoIP). It is known to improve such systems for VoIP traffic using hybrid automatic repeat request (HARQ) error correction schemes and smaller packet sizes. While VoIP users have the same benefits of advanced link adaptation and statistical multiplexing as data users, a greatly increased number of voice users may be served because of the smaller voice packet sizes. Unfortunately, the large number of voice users places a burden on the control mechanisms of the system. It can be easily envisioned, for example, that 30 times as many voice packets could be served in a given time period than data packets. There are typically about 1500 bytes for data and about 15-50 bytes for voice in a single packet, depending on the vocoder rate. (Note that generally in the art when the term “data” is used, it signifies payload information for any service, whether voice or data, unless the context indicates that “data” is intended to refer to payload information associated with non-voice services).

It is known to group multiple voice users together which share a set of time-frequency resources. Further, it known to use bitmap signaling to efficiently allocate portions of the shared time-frequency resources to the set of voice users sharing the same time-frequency resource. However, these techniques do not allow an efficient means of indicating special transmissions. For example, the techniques do not allow transmitting two packets to the same user one with minimal signaling overhead. As an additional example, the techniques do not allow allocating a specific resource to a specific access terminal (AT). Thus, there is a need for efficiently and flexibly indicating special transmissions of various types, while still maintaining the basic bitmap signaling structure.

### BRIEF DESCRIPTION OF THE DRAWINGS

FIG. 1 is an illustrative wireless communication network.

FIG. 2 is an illustrative sequence of wireless frames each comprising a plurality of time slots.

FIG. 3 is an illustrative example of a sequence of repeating wireless frames each comprising a plurality of time slots.

FIG. 4 is an illustrative example of a set of shared resources.

FIG. 5 is a block diagram of resource assignment information.

FIG. 6 illustrates a resource assignment bitmap.

FIG. 7 illustrates shared resources and a typical ordering pattern.

FIG. 8 illustrates a first exemplary resource allocation policy.

FIG. 9 is a block diagram of resource assignment information in accordance with multiple embodiments of the present invention.

FIG. 10 illustrates a second exemplary resource allocation policy.

FIG. 12 is a block diagram of a base station in accordance with multiple embodiments of the present invention.

FIG. 13 is a flow chart showing operation of the base station of FIG. 12 in accordance with multiple embodiments of the present invention.

FIG. 14 is a block diagram of a wireless terminal in accordance with multiple embodiments of the present invention.

FIG. 15 is a flow chart showing operation of the wireless terminal of FIG. 14 in accordance with multiple embodiments of the present invention.

The various aspects, features and advantages of the present disclosure will become more fully apparent to those having ordinary skill in the art upon careful consideration of the following Detailed Description thereof with reference to the accompanying drawings, which have been simplified for clarity and are not necessarily drawn to scale.

### DETAILED DESCRIPTION

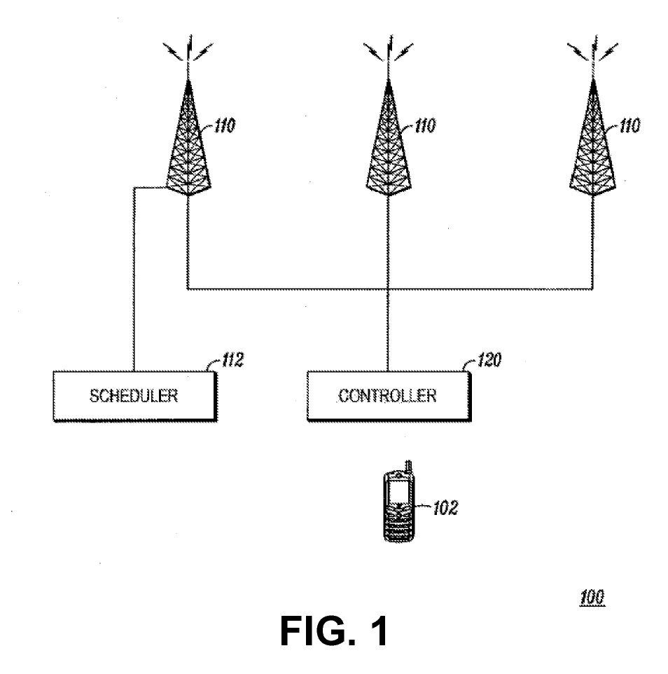

FIG. 1 depicts a wireless digital communication system 100 comprising a plurality of base transceiver stations 110 providing wireless communication service including voice and/or data service to wireless terminal 102 over corresponding regions or cellular areas. The base transceiver stations (BTSs), also referred to by other names such as base station, “Node B”, and access network (AN) depending on the system type, are communicably coupled to a controller 120 and to other entities that are not shown but are well known by those having ordinary skill in the art. As depicted in FIG. 1, each base transceiver station includes a scheduling entity 112 for wireless resource scheduling among the wireless communication terminals within the system. Exemplary communication systems represented by wireless digital communication system 100 include, but are not limited to, developing Universal Mobile Telecommunications System (UMTS) networks, Evolved UMTS Terrestrial Radio Access (E-UTRA) networks, Evolved High Rate Packet Data (E-HRPD) networks, and other orthogonal frequency division multiplexing (OFDM) based networks.

E-HRDP, E-UTRA and other communication protocols are being developed to support delivery of voice services over a packet domain, in contrast to the traditional delivery of voice over a circuit switched domain. Thus, there is interest in schemes that support voice traffic over a shared wireless channel, wherein multiple users share the time and frequency resources of the wireless interface. In order to attain a significant increase in capacity with E-HRPD and E-UTRA, efficient wireless resource allocation schemes will likely be required to accommodate voice traffic. In these and other applications, including data applications, it is generally desirable that control signaling overhead be minimized while offering flexibility to the scheduler at the network. In a general sense, it is useful to define a mechanism to efficiently signal resource allocation and related control channel information to multiple terminals, relying on shared channels for delivery of any service using packet based transmission.

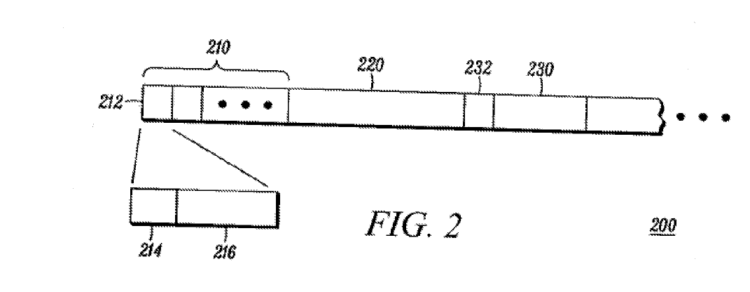

FIG. 2 illustrates a sequence of wireless frames 200 useful for communicating in wireless digital communication systems. As depicted in FIG. 2, the frame sequence generally comprises a plurality of frames 210, 220, 230 . . . , wherein each frame comprises a plurality of time slots. For example, frame 210 comprises a time slot 212 having a resource assignment control channel portion within a control channel portion 214 and a data channel portion 216. In some embodiments, the frames constitute a repeating sequence of frames, wherein the repeating sequence may be periodic or a-periodic.

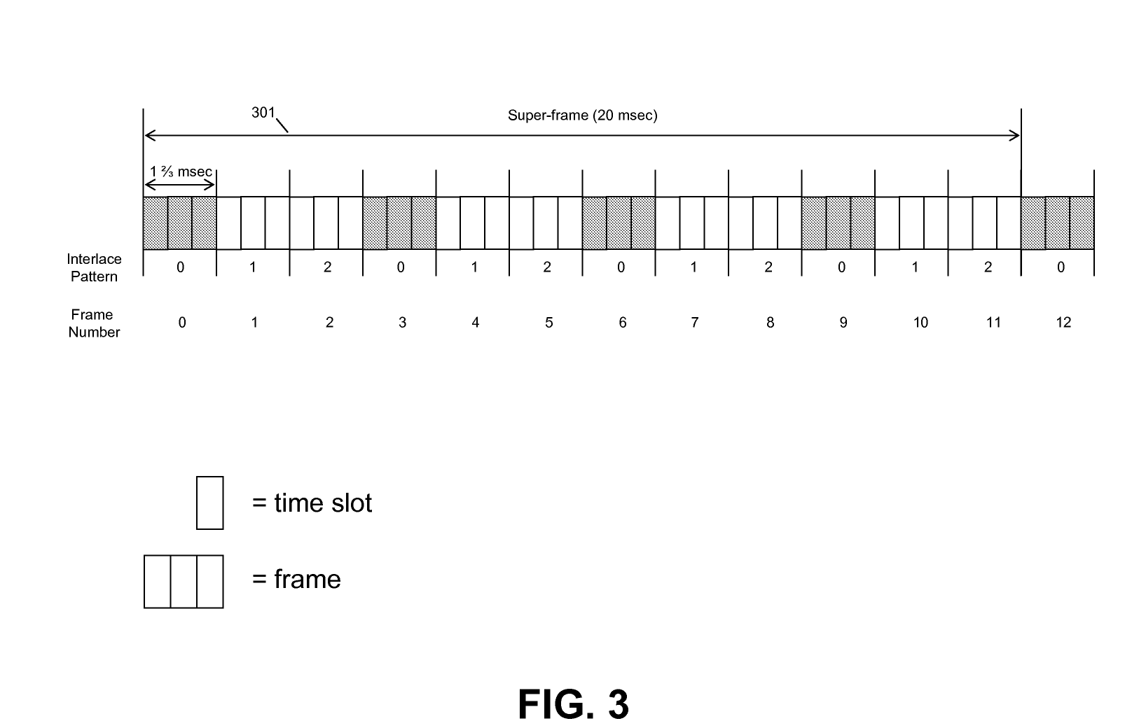

FIG. 3 illustrates a sequence of repeating frames, wherein three time slots are grouped to form a frame. As depicted in FIG. 3, each time slot is 5/9 msec and each frame is 5/3 msec, although the timing may be different in other embodiments. For example, in another embodiment, two time slots of ⅚ msec are concatenated to form a 5/3 msec frame. In yet another embodiment, one ⅚ msec slot is defined as a frame. An interlace pattern is defined as a repeating sequence of frames. For systems employing synchronous HARQ (S-HARQ), the initial and subsequent HARQ transmissions typically occur in the same interlace pattern. In this illustrative example, 12 frames, denoted frame 0 through 11, occupy a 20 msec time interval, which is defined as a super-frame 301 and is the duration of a vocoder frame for many wireless standards.

For orthogonal frequency division multiple access (OFDMA) systems, such as those being considered for E-UTRA and E-HRPD, the frequency domain is divided into subcarriers. For example, for a 5 MHz OFDMA carrier, there may be 464 useful subcarriers, where the subcarrier spacing is 9.6 kHz. Similarly, a time slot is divided into multiple OFDM symbols. For example, a time slot may occupy 5/9 msec and contain 5 OFDM symbols, where each symbol occupies approximately 110.68 usec. The subcarriers are grouped to form frequency selective resource elements (FSRE) and frequency distributive resource elements (FDRE). An FSRE is a group of contiguous subcarriers, while an FDRE is a group of noncontiguous sub-carriers.

In one embodiment, a scheduler or other infrastructure entity in a wireless communication system groups wireless communication terminals in one or more groups for scheduling purposes. Any entity or terminal that may be scheduled by the scheduler is referred to as a schedulable wireless communication entity. In one embodiment, the entities or terminals may be grouped based on wireless channel conditions associated with the terminals, for example, channel quality information reported by the terminals, Doppler reported by the terminal, distance from the serving cell, among others. In another embodiment, the terminals are grouped based on one or more terminal operating characteristics other than participation in a common communication session. Exemplary terminal operating characteristics include power headroom of the terminals, macro diversity considerations, terminal capability, service of the terminals, codec rate among others. In yet another embodiment, terminals with an active VoIP session are grouped together. Once the scheduler establishes a group of wireless communication terminals, the BTS sends an indication to each wireless terminal of its position in the group and an indication of the identifier for the group. The identifier for the group is used if the BTS needs to send control information valid for the entire group. For example, the BTS may change the frequency allocation for the group by sending an indication of the group identifier and an indication of the new frequency allocation. The position indications may be sent for each wireless terminal separately or may be sent for a plurality of wireless terminals at once. For example, the BTS may transmit a list of wireless terminal unique identifiers along with a group identifier. The first terminal in the list of unique identifiers is assigned the first position, the second terminal in the list of unique identifiers is assigned the second position, etc. The unique identifier may be a mobile communication device or wireless terminal identification number, a subscriber identity, or any other identifier that may be used to uniquely identify a wireless terminal. For example, the unique identifier may be a medium access control index (MAC Index). As another example, the BTS may transmit the unique identifier for one wireless terminal, an identification of the group identifier, an indication of the wireless terminal's position within the group. The indications may be transmitted on a control channel.

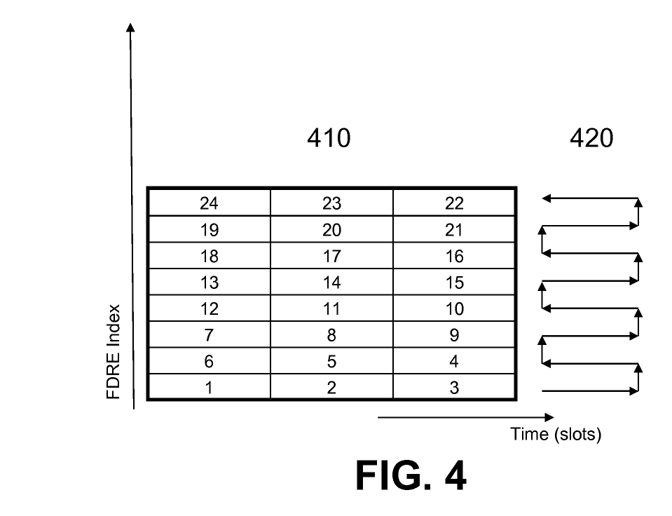

For each group of schedulable wireless communication entities, the scheduler may assign a set of time-frequency resources to be shared by the entities or terminals in the group. FIG. 4 shows an example of a set of shared resources. As depicted in FIG. 4, the shared resources 410 are three time slots and eight FDREs. If a block is defined as one time slot in the time domain and one FDRE in the frequency domain, then there are 24 blocks (blocks are also called resource blocks or simply resources), denoted 1 through 24. Recall that FDREs are groups of non-contiguous subcarriers, so the FDRE Index of FIG. 4 is a logical representation of the frequency domain. As will be discussed later, each wireless terminal determines its portion of the shared resource, based on the assignments for other wireless terminals. Therefore, it is necessary to define the order in which the resources are to be allocated. In FIG. 4, an illustrative normal ordering pattern 420 is given, which results in the blocks being numbered 1 through 24. The set of shared resources may be repeatedly used in an interlace pattern as described with respect to FIG. 3. For example, the 24 resources may be repeatedly used in each frame of interlace pattern 0 as depicted in FIG. 3. Again, these 24 resources are logical representation of a set of sub-carriers in the frequency domain in a time slot; the exact physical location of these sub-carriers may change from time slot to time slot.

An indication of the set of shared resources and the normal ordering pattern may be signaled from the BTS to the wireless terminal using a control channel. Further, the control channel may be transmitted in any time slot with a pre-defined relationship with the beginning time slot of the set of shared resources. The set of shared resources may begin in the same slot the control channel is transmitted, may have a fixed starting point relative to the time slot that the control channel is transmitted, or may be explicitly signaled in the control channel.

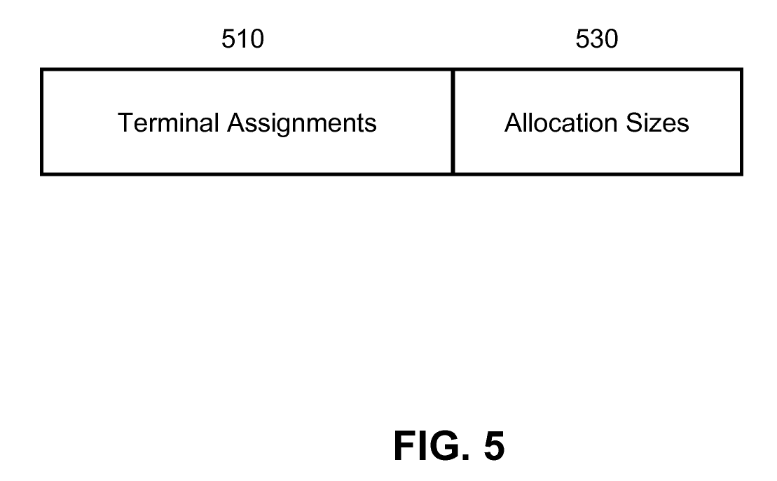

Once the scheduler assigns a plurality of wireless terminals to a group of wireless terminals, assigns each wireless terminal a position (also called location) within the group, and assigns a set of shared resources to the group of wireless terminals, the scheduler indicates to the set of wireless terminals which wireless terminals are active in a given time period and, in some embodiments, the number of assigned resources assigned to each wireless terminal. FIG. 5 depicts an exemplary technique for assigning resources to wireless terminals. A first field, terminal assignments 510, indicates which wireless terminals are assigned at least one of the shared resources in the corresponding set of shared resources. For example, field 510 could be a first bitmap, where the position of the wireless terminal within the group of wireless terminals corresponds to its bitmap position. For example, the wireless terminal assigned position 1 determines if it is assigned one of the shared resources using position 1 of the bitmap, the wireless terminal assigned position 2 determines if it is assigned one of the shared resources using position 2 of the bitmap, etc.

While a bitmap position is typically one bit, it is understood that a bitmap position may be more than one bit. For example, a bitmap position may consist of two bits, where the wireless terminal assigned position 1 determines if it is assigned one of the shared resources using the first two bits of the bitmap, the wireless terminal assigned position 2 determines if it is assigned one of the shared resources using the third and fourth bits in the bitmap, etc. When one bit per wireless terminal is used in the bitmap, active users may be indicated using either a ‘0’ or a ‘1’, where inactive users are indicated using the opposite state. In the illustrative examples, active users are indicated using a ‘1’ In some embodiments, a single bit, denoted the invert normal ordering pattern bit, is appended to the first bitmap, where the value of the bit indicates whether to follow the normal ordering pattern in ascending or descending order. For example, a ‘0’ may indicate to use normal ordering pattern in ascending order (not inverted), while a ‘1’ may indicate to use the normal ordering pattern in descending order (inverted). The bit may have any location within the first bitmap, as long the wireless terminals know its location. In a related embodiment, several normal ordering patterns are established, and the BTS indicates the desired normal ordering pattern by appending a normal ordering field to the first bitmap. Then, at each scheduling instance, the BTS indicates the desired normal ordering using the normal ordering field.

The allocation sizes field 530 indicates wireless resource assignment weighting information to the schedulable wireless communication entities to which wireless resources have been assigned. In one embodiment, the wireless resource assignment weighting information indicates a proportion of wireless resources assigned to each schedulable wireless communication entities to which wireless resources have been assigned. In another embodiment, the wireless resource assignment weighting information indicates a specified number or size of wireless resources assigned to each schedulable wireless communication entity to which wireless resources have been assigned. In some embodiments, the wireless resource assignment weighting information also includes at least one of vocoder rate, modulation, and coding information. If there is only one possible weighting value, the allocation sizes field 530 may be omitted. The terminal assignments field 510 and the allocation sizes field 530 may be transmitting on a shared control channel, where each wireless terminal in the group decodes the shared control channel.

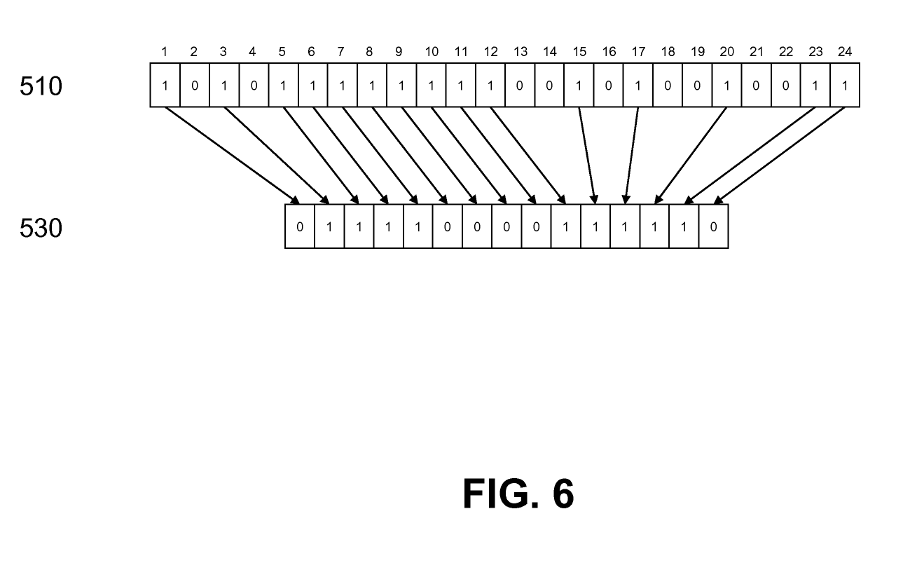

As an illustrative example, FIG. 6 shows an exemplary first and second bitmaps for allocating resources. As depicted in FIG. 6, 24 wireless terminals are assigned to a group of wireless terminals and are assigned group positions 1 through 24, which correspond to positions 1 through 24 in the first bitmap. Active wireless terminals are indicated with a ‘1’ in the first bitmap. The first bitmap is an exemplary terminal assignments field 510 from FIG. 5. The second bitmap is an exemplary allocation sizes field 530, wherein the Nth active user in the first bitmap corresponds to the Nth position in the second bitmap. A ‘0’ in the allocation size field indicates that 1 resource is allocated to the corresponding wireless terminal and a ‘1’ indicates that 2 resources are allocated to the corresponding wireless terminal. The wireless terminal assigned group position 1, denoted WT₁, and therefore position 1 in the first bitmap is an active wireless terminal as indicated by the ‘1’ in bitmap position 1. Therefore, WT₁ determines its allocation size using the first position in the second bitmap 530. Since a ‘0’ is indicated in the first position in the second bitmap, WT₁ is allocated 1 resource. The wireless terminal assigned group position 2, denoted WT₂, and therefore position 2 in the first bitmap is not an active wireless terminal as indicated by the ‘0’ in the first bitmap. Therefore, WT₂ is not allocated any resources and is not found in the second bitmap 530. The wireless terminal assigned group position 3, denoted WT₃, and therefore position 3 in the first bitmap is an active wireless terminal as indicated by the ‘1’ in bitmap position 3. WT₃ is the second active wireless terminal indicated in the first bitmap and, therefore, WT₃ determines its allocation size using the second position in the second bitmap 530. Since a ‘1’ is indicated in the second position in the second bitmap, WT₃ is allocated 2 resources. These allocation policies are repeated for all 24 wireless terminals. Note that the second bitmap could be the same size as the first bitmap, which would eliminate the need to map assigned terminals in the first bitmap to positions in the second bitmap.

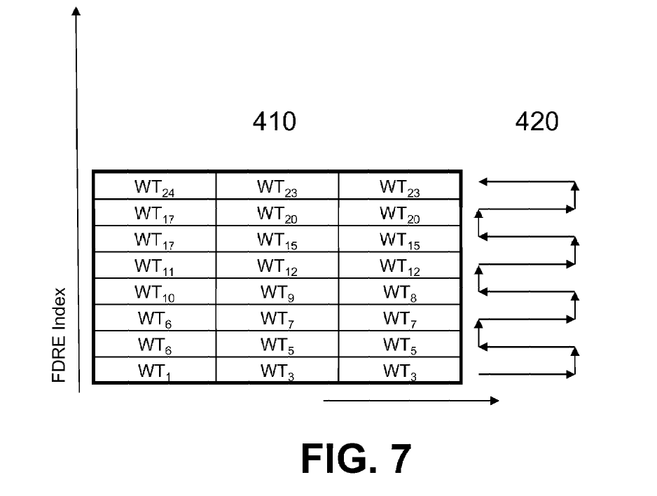

Combining the allocation policies illustrated in FIG. 6 and the set of shared resources 410 and normal ordering pattern 420 illustrated in FIG. 4, each wireless terminal may determine its portion of the shared resources as depicted in FIG. 7. The first active wireless terminal, WT₁, is assigned one resource, and since it is the first wireless terminal allocated, it is allocated resource 1 of FIG. 4. The second active wireless terminal, WT₃, is assigned two resources. WT₃ sums the number of resources allocated to wireless terminals with a smaller position in the second bitmap. In this case, WT₃ determines that one resource was previously assigned. Therefore, WT₃ is assigned resource 2 and 3 of FIG. 4. The third active wireless terminal, WT₅, is assigned two resources. WT₅ sums the number of resources allocated to wireless terminals with a smaller position in the second bitmap. In this case, WT₅ determines that 3 resources were previously assigned (1 for WT₁ and 2 for WT₃). Therefore, WT₅ is assigned resources 4 and 5 of FIG. 4. This process is repeated for all wireless terminals.

For certain applications, such as voice, packets arrive at a relatively constant rate. For example, for voice, vocoder frames arrive approximately every 20 msec. As an illustrative example and referring again to FIG. 3, consider that vocoder frames arrive approximately every 20 msec beginning at the beginning of long frame number 0. Typically, the BTS appends any necessary headers to vocoder frame and encodes it to form a voice packet. The BTS then modulates and transmits at least a portion of the symbols comprising the voice packet to the wireless terminal in long frame number 0. This is denoted the first HARQ transmission. The wireless terminal then receives and attempts to decode the transmitted packet. If the wireless terminal successfully decodes the voice packet after the first HARQ transmission, it sends an acknowledgement (ACK) to the BTS. Upon receiving an ACK, the BTS does not transmit any additional information to the wireless terminal in frames 3, 6, and 9 (bitmap signaling allows these resources to be used by other wireless terminals). If the wireless terminal was not able to successfully decode the voice packet, it sends a negative acknowledgement (NACK) to the BTS. Upon receiving a NACK, the BTS sends additional symbols of the voice packet, denoted the second HARQ transmission, to the wireless terminal in frame number 3. If the wireless terminal successfully decodes the voice packet after the second HARQ transmission, it sends an acknowledgement (ACK) to the BTS. Upon receiving an ACK, the BTS does not transmit any additional information to the wireless terminal in frames 6, and 9. If the wireless terminal was not able to successfully decode the voice packet, it sends a negative acknowledgement (NACK) to the BTS. Upon receiving a NACK, the BTS sends additional symbols of the voice packet, denoted the third HARQ transmission, to the wireless terminal in frame number 6. If the wireless terminal successfully decodes the voice packet after the third HARQ transmission, it sends an acknowledgement (ACK) to the BTS. Upon receiving an ACK, the BTS does not transmit any additional information to the wireless terminal in frame 9. If the wireless terminal was not able to successfully decode the voice packet, it sends a negative acknowledgement (NACK) to the BTS. Upon receiving a NACK, the BTS sends additional symbols of the voice packet, denoted the fourth HARQ transmission, to the wireless terminal in frame number 9. If the wireless terminal successfully decodes the voice packet after the fourth transmission, it sends an acknowledgement (ACK) to the BTS. If the wireless terminal was not able to successfully decode the voice packet, it sends a negative acknowledgement (NACK) to the BTS.

If the BTS receives a NACK after the fourth HARQ transmission, the current bitmap signaling mechanisms do not allow the BTS to simultaneously continue transmitting the current voice packet (i.e. transmit a fifth HARQ transmission) and begin transmitting a new voice packet in frame number 12. More particularly, the BTS chooses whether to continue transmitting the current voice packet or begin transmitting the new voice packet. If the BTS chooses to continue transmitting the current voice packet, the new voice packet will be delayed, which degrades voice quality. If the BTS chooses to transmit the new voice packet, the current voice packet will be declared in error, which also degrades voice quality. Thus, there is a need for simultaneously and efficiently transmitting more than one voice packet to a wireless terminal, while still maintaining the efficient bitmap signaling methods, which minimize control channel overhead.

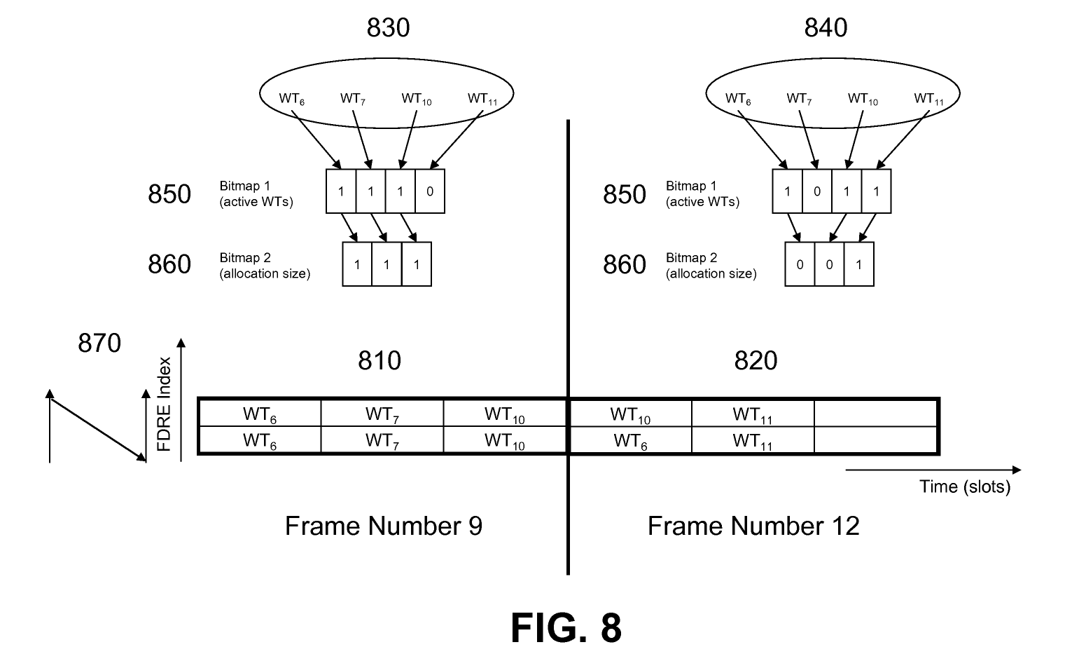

As an example of the described problem, consider the scenario depicted in FIG. 8. Referring to FIG. 8, frames 9 and 12 from FIG. 3 are illustrated. A group of four wireless terminals (WT₆, WT₇, WT₁₀, and WT₁₁) 830 are assigned to group, assigned group positions 1 through 4, and assigned a frequency domain resources within the interlace containing frames 9 and 12 (interlace 0). In particular, the set of shared time-frequency resources is comprised of two FDREs in each of three time slots for a total of 6 blocks in each frame 810 and 820. Further, consider that the BTS uses two bitmaps to schedule wireless terminals, where the first bitmap 850 indicates active wireless terminals, and the second bitmap 860 indicates the size of the allocation for each active wireless terminal as previously described. Consider the case where a ‘0’ in the second bitmap indicates that one block is assigned, and a ‘1’ in the second bitmap indicates that two blocks are assigned. Consider that WT₆, WT₇, WT₁₀ are receiving their fourth transmission of their respective first voice packets and that WT₁₁ has already acknowledged its transmission of its first voice packet. Finally, consider that the scheduler has determined that WT₆, WT₇, WT₁₀ require two resources in frame 9. Resources are allocated according the normal ordering pattern 870.

Referring to FIG. 8, the scheduler assigns WT₆, WT₇, and WT₁₀ in frame 9 as indicated by the first bitmap and assigns block sizes as indicated by the second bitmap. Due to the normal ordering pattern 870 and the values in the bitmaps, the three wireless terminals are allocated the resources as seen in 810. Consider the case where WT₆ and WT₇ send an ACK to the BTS after frame 9 and WT₁₀ sends a NACK to the BTS after frame 9. Further consider that WT₆, WT₁₀, and WT₁₁ have a second voice packet, which needs to be transmitted beginning in frame 12. Since WT₁₀ did not correctly decode its first voice packet, the BTS chooses whether to continue transmitting its first voice packet or to begin transmitting its second voice packet. In this illustrative example, the BTS chooses to transmit the second voice packet to WT₁₀. Since WT₆ and WT₁₁ acknowledged their respective first voice packets, the BTS will transmit the respective second voice packets to WT₆ and WT₁₁ beginning in frame 12. Consider that the scheduler has determined that WT₆ and WT₁₀ require one resource in frame 12, while WT₁₁ requires two resources. Referring to FIG. 8, the scheduler assigns WT₆, WT₁₀, and WT₁₁ in frame 12 as indicated by the first bitmap and assigns block sizes as indicated by the second bitmap. Due to the normal ordering pattern 870 and the values in the bitmaps, the three wireless terminals are allocated the resources as seen in 820. Using this signaling method, the BTS was unable to simultaneously transmit a fifth transmission for the first VoIP packet and a first transmission for the second VoIP packet for WT₁₀.

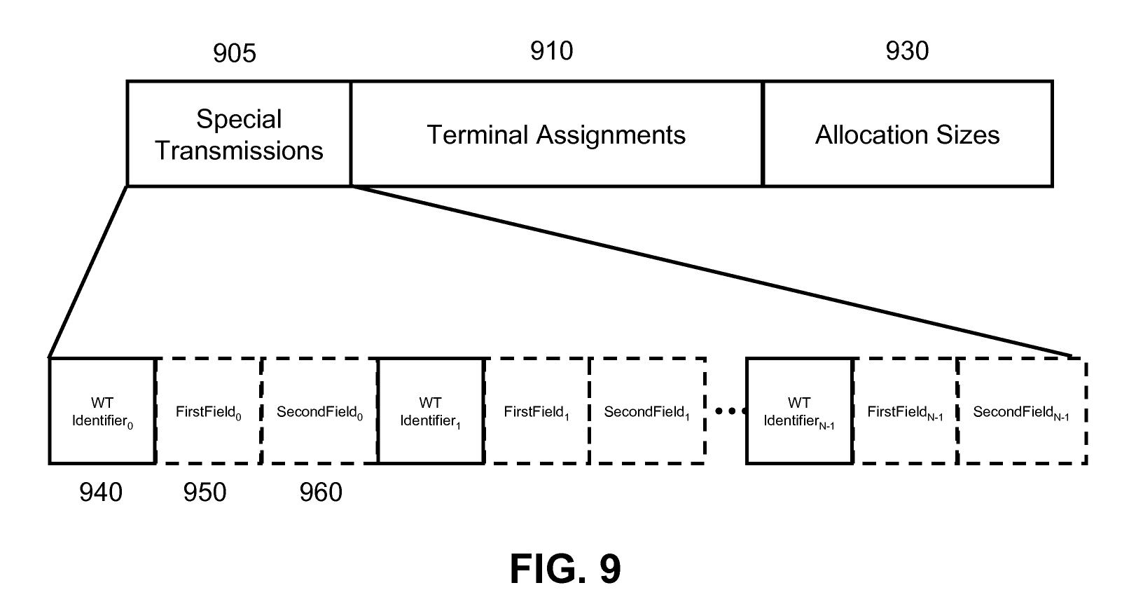

To mitigate the described problem, a new control channel bitmap, denoted special transmissions, is transmitted to the group of wireless terminals sharing a set of time-frequency resources to indicate to the group which wireless terminals are receiving a special transmission. This field is depicted in FIG. 9, where the special transmissions field 905 is inserted in the shared control channel message prior to the previously defined terminal assignments 910 and allocation sizes 930 fields. Note that the special transmissions field may occur in any location within the control channel. For example, in another embodiment, the special transmissions field occurs after the terminal assignments 910 and allocation sizes 930 fields. The special transmissions field facilitates the simultaneous transmission of two voice packets to one wireless terminal, as well as additional special transmissions as will be described in more detail later. The special transmissions field contains the identifier of the wireless terminal (WT identifier field 940) and N optional associated fields, where N is an integer greater than or equal to 0. Referring to FIG. 9, two optional fields are indicated, namely the FirstField and the SecondField. To mitigate the problem described in FIG. 8, the FirstField 950 may be a reserved blocks field 950, while the SecondField 960 may be a HARQ transmission number field 960. The three fields are indicated for each wireless terminal with a special transmission. Each series of fields 940, 950, and 960 indicate one special transmission for one wireless terminal. The number of allowed special transmissions may be fixed in the system, indicated on a different control channel, determined using blind detection, determined based on the group size, or the like. In a related embodiment, the special transmission field 905 is not appended to the terminal assignments field 910 and allocation sizes field 930, but is rather separately encoded and transmitted.

The WT identifier field 940 is an indication of which wireless terminal is receiving a special transmission. Typically, the WT identifier is the binary representation of the wireless terminal's position within the group. Recall that the wireless terminal's position within the group corresponds to its bitmap position. The WT identifier could also be a sector specific identifier (such as a MAC Index) or a system specific unique identifier.

The reserved blocks field is an indication to the users of the group sharing a set of time-frequency resources of the number of blocks being used for each special transmission. Typically, the reserved blocks field is a bitmap, where the bitmap is a direct mapping of binary to decimal. For example, if three bits are allocated for the reserved blocks field, then ‘000’ indicates that 0 blocks are reserved, ‘001’ indicates that 1 block is reserved, ‘010’ indicates that 2 blocks are reserved, ‘011’ indicates that 3 blocks are reserved, etc. However, other mappings are possible. For example, a simple non-linear representation of the three bits could be used such that ‘000’ indicates that 0 blocks are reserved, ‘001’ indicates that 1 block is reserved, ‘010’ indicates that 2 blocks are reserved, ‘011’ indicates that 4 blocks are reserved, ‘100’ indicates that 8 blocks are reserved, ‘101’ indicates that 12 blocks are reserved, ‘110’ indicates that 16 blocks are reserved, ‘111’ indicates that 32 blocks are reserved. Any linear or non-linear mapping of the reserved blocks field to the actual number of reserved blocks is possible, as long as the scheduler at the BTS and the wireless terminals know the mapping. It is envisioned that more resources may be reserved than end up being used, and, although this is slightly inefficient, it is sometimes desirable. For example, it reduces the overhead in the reserved field used in specifying the number of resource blocks reserved when non-linear mappings are used. The mapping may be transmitted on a control channel or may be stored at the wireless terminal as a default value.

The HARQ transmission number field is an indication of the HARQ transmission number that the wireless terminal indicated in the WT identifier field 940 is receiving. Such information may be used by the wireless terminal when decoding the VoIP transmission, and is particularly desirable when a wireless terminal misses one or more control channels during the transmission of a given packet. For example, if the BTS is transmitting the fifth transmission for the wireless terminal with the twelfth group position using one block, then the WT identifier field 940 would be ‘1100’, the reserved blocks field 950 would be ‘001’, and the HARQ transmission number field 960 would be ‘101’.

There are several additional fields that may be used as the FirstField 950 or the SecondField 960. First, a vocoder rate field could be used to indicate the vocoder rate of the special transmission. This helps relieve the processing burden at the wireless terminal by eliminating the requirement of performing blind rate detection. For example, the vocoder rate field could be a two bit field, where ‘00’ indicates an eighth rate vocoder frame, ‘01’ indicates a quarter rate vocoder frame, ‘10’ indicates a half rate vocoder frame, and ‘11’ indicates a full rate vocoder frame. Second, a packet data field could used to indicate the presence and packet size of a packet data transmission to a particular wireless terminal. This is advantageous for indicating packet data transmissions to a group of users which typically receive VoIP packets. For example, the packet data field could be a two bit field, where ‘00’ indicates a 128 bit data packet, ‘01’ indicates a 256 bit data packet, ‘10’ indicates a 512 bit data packet, and ‘11’ indicates a 1024 bit data packet. As an example, the data packet could be a SMS (short message service) message. Third, an allocated block field could be used to indicate the beginning block for each special transmission. For example, for certain situations such as soft handoff, it may be desirable to allocate a particular wireless terminal to a particular shared time-frequency resource. In this case, an allocated block field is used to indicate the first block of the special transmission. The remaining wireless terminals simply skip any resources indicated in the allocated blocks field when determining their allocations. For example, consider the case where the BTS would like to allocate the eighth shared resource to the wireless terminal with the sixth group position. The BTS then indicates ‘110’ in the WT identifier field and ‘1000’ in the allocated block field.

As previously mentioned, the allocated block field may be used for soft handoff. To understand this, consider a wireless terminal that is located between two sectors, denoted sector A and sector B. Further consider that the wireless terminal is assigned to a VoIP group in sector A which shares a particular set of time-frequency resources, and there is a similar group in sector B which shares the same set of time-frequency resources (the wireless terminal is not a member of the group in sector B). Consider that the wireless terminal then indicates its desire for the BTS to simulcast its VoIP packet from sector A and sector B. For simulcast, the same time-frequency resource is be used in both sector A and sector B. To do this, sector A indicates which of the set of shared time-frequency resources the wireless terminal is allocated to sector B, and sector B indicates a special transmission for the wireless terminal by indicating the MAC Index of the wireless terminal in the WT identifier field and the assigned block in sector A using the allocated block field. These fields are transmitted in the shared control channel of sector B.

In the most general form, the special transmissions field indicates the identifier of the wireless terminal and, optionally, at least one additional field, where the additional field is taken from the reserved blocks field, HARQ transmission number field, vocoder rate field, packet data field, and allocated block field.

Again, to mitigate the problem described by FIG. 8, consider the case when a reserved blocks field is used as the FirstField and HARQ transmission number is used as the SecondField. If a wireless terminal observes its identifier in one of the WT identifier fields 940, it knows it is receiving a special transmission. It then determines number of blocks for the special transmission according to the corresponding reserved blocks field and the HARQ transmission number from the corresponding HARQ transmission number field. Blocks for special transmissions may be allocated according to a special transmission allocation policy. For example, special transmissions may be allocated at the beginning of the set of shared resources, at the end of the set of shared resources (possibly in reverse order), immediately following the blocks allocated using the first and second bitmaps, or in any other location as long as the BTS and the wireless terminals know the location. The special transmission allocation policy may be a beginning resource block and a special ordering. The BTS may indicate the special transmission allocation policy on a control channel. If the blocks are allocated at the beginning of the set of shared resources, the first wireless terminal receiving a special transmission is allocated the number of blocks indicated in the first reserved blocks field 950 beginning at block 1. The second wireless terminal receiving a special transmission is allocated the number of blocks indicated in the second reserved blocks field beginning at block 1 plus the number of blocks indicated in the first reserved blocks field. This process is repeated for all wireless terminals receiving a special transmission. The wireless terminals that are indicated in the terminal assignments field 910 then begin allocating resources in the typical manner beginning with the block immediately following the last block used for special transmissions. Note that a wireless terminal may be indicated in both the special transmissions field 905 and the terminal assignments field 910. In this way, the wireless terminal may be simultaneously allocated resources for more than one packet. Note that the BTS may indicate two special transmissions for a particular wireless terminal by indicating the same WT identifier in multiple WT identifier fields 940.

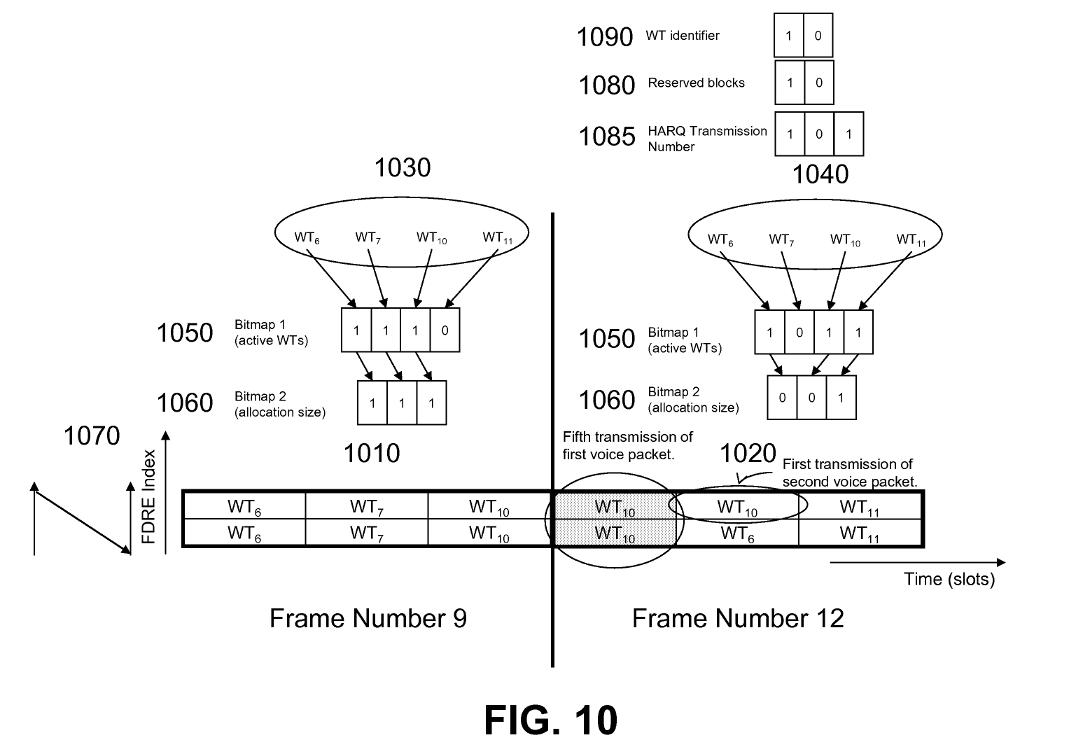

FIG. 10 illustrates how the special transmissions field is used to simultaneously allocate resources for more than one packet to the same wireless terminal. The scenario of FIG. 10 is the same as FIG. 8, except where indicated otherwise. Recall that, at the beginning of frame 12, the BTS has in its queue the second voice packet for WT₆, WT₁₀, and WT₁₁ and an unacknowledged first voice packet for WT₁₀. Using the special transmissions field, this example illustrates how the BTS simultaneously allocates resources for both the first and second voice packets for WT₁₀. The BTS transmits as part of the control channel a special transmissions field, comprised of the WT identifier field, 1090, reserved blocks field 1080, and HARQ transmission number field 1085. In this example, special transmissions are allocated the first blocks in the set of shared resources, and the special ordering is equivalent to the normal ordering. Further, the reserved blocks field is a bitmap that is a direct mapping of binary to decimal. Consider that the BTS has determined that the fifth transmission of the first voice packet for WT₁₀ requires two blocks. To indicate the special transmission for WT₁₀, the BTS indicates in 1090 the location or position of WT₁₀ within the group. WT₁₀ corresponds to the third position in the bitmap. In this example, the third position corresponds binary ‘10’, since the first position corresponds to binary ‘00’. In other embodiments, the third position may correspond to binary ‘11’ depending on how the zero position is defined. The BTS indicates that two blocks are allocated for the special transmission for WT₁₀ using ‘10’ in the reserved blocks field 1080. Finally, the BTS indicates a fifth HARQ transmission in HARQ transmission number field using ‘101’. WT₁₀ decodes the control channel and determines that it is allocated a special transmission occupying two blocks. The two blocks are the first two blocks in the set of shared time-frequency resources, since special transmissions are allocated first according to the special ordering. Each terminal receiving the control channel message determines that two blocks are being used for special transmissions and then begins allocating resources in the typical manner according the first and second bitmaps. Due to the normal ordering pattern 1070 and the values in the bitmaps, WT₆, WT₁₀, and WT₁₁ are allocated the resources as seen in 1020. For example, WT₆ determines that it is active using the first bitmap 1050, determines that it is allocated one block using the second bitmap 1060, and determines that it is allocated block number 3, since two blocks were allocated for special transmissions. WT₁₀ determines that it is active using the first bitmap 1050, determines that it is allocated one block using the second bitmap 1060, and determines that it is allocated block number 4, since two blocks were allocated for special transmissions and one block was previously allocated to other wireless terminals in the first and second bitmaps. This process is repeated for WT₁₁. Using the special transmissions field 1080, 1085, and 1090, the BTS was able to indicate that WT₁₀ was receiving two voice packets simultaneously. In some embodiments, the HARQ transmission number field is omitted. In this case, WT₁₀ knows which assignment is for the fifth transmission of the first voice packet, and which assignment is for the first transmission of the second voice packet. In the preferred embodiment, transmissions continued beyond a normal boundary are indicated as special transmissions, while new transmissions are indicated using the normal first and second bitmaps, although the opposite is also possible as long as the BTS and wireless terminal agree on the policy.

In another embodiment, the reserved blocks and WT identifier fields are used to indicate that a particular wireless terminal is receiving a special transmission, which is not necessarily a continued transmission. For example, the RTP/UDP/IP (real-time transport protocol/user datagram protocol/internet protocol) overhead that is added to the vocoder packet prior to encoding could be significantly larger than normal. In this case, the WT identifier would indicate the WT for which the special transmission is intended, and the reserved blocks field would indicate the packet size for the extended RTP/UDP/IP packet and the number of blocks allocated for this packet.

In yet another embodiment, the identifiers of the wireless terminals allocated special transmissions are indicated using a bitmap, where each position in the bitmap corresponds to one of the shared time-frequency resources. When a ‘1’ is indicated in the bitmap, the wireless terminal allocated the corresponding time-frequency resource in the previous frame is allocated a special transmission in the current frame. This is particularly advantageous when there is not an allocation sizes field (only terminal assignments) and there are several wireless terminals requiring special transmissions. In this embodiment, each wireless terminal allocated a special transmission is allocated one block.

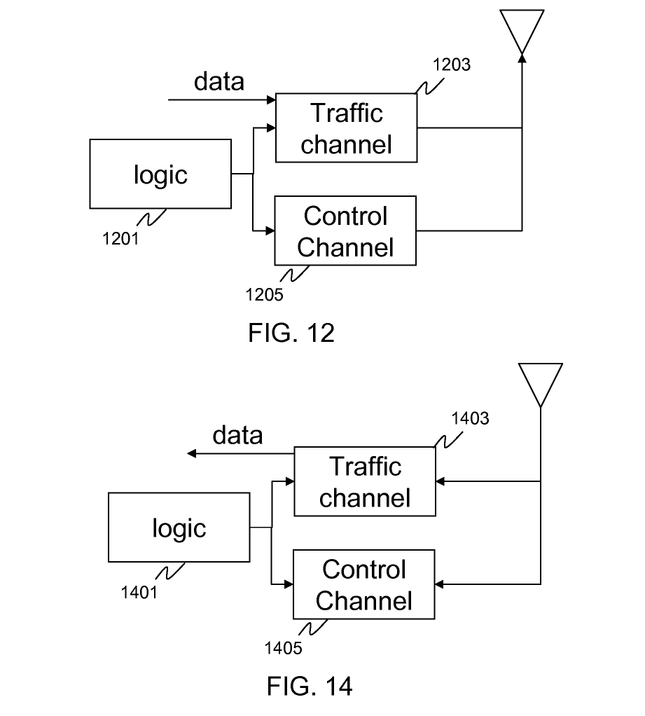

FIG. 12 is a block diagram of a base station. As shown, base station 110 comprises logic circuitry 1201, traffic channel circuitry 1203, and control channel circuitry 1205. During operation, data enters traffic channel circuitry 1203 and is transmitted to the appropriate wireless terminal 102 utilizing the appropriate shared resource from a set of shared resources (i.e., time slot(s) and subcarrier(s), possibly within a particular interlace).

As described above, control channel circuitry 1205 transmits appropriate control information to a set of terminals 102. The control information comprises terminal assignments 910 that notify each terminal of its assigned resource. Allocation sizes 930 are also transmitted by control channel circuitry 1205. As discussed above, the allocation sizes field comprises an amount of the shared resources that a particular terminal is allocated.

When logic circuitry 1201 determines that a special transmission is required for a particular wireless terminal, logic circuitry 1201 will instruct control channel circuitry 1205 to broadcast the WT identifier field 940 as part of the special transmissions field of the shared control channel for each wireless terminal receiving a special transmission. If a reserved blocks field is used, logic circuitry 1201 will determine an amount of resources needed for each wireless terminal for which a special transmission is required, and then instruct control channel circuitry 1205 to broadcast a reserved blocks field 940 as part of the special transmissions field of the shared control channel. The reserved blocks field 940 will indicate to the users of the set of shared resource blocks exactly how many resources are being utilized by terminals receiving special transmissions. If any one of the HARQ transmission number field, vocoder rate field, packet data field, and allocated block field are being used, logic circuitry 1201 will determine the appropriate value for the field, and then instruct control channel circuitry 1205 to broadcast the field as part of the special transmissions field shared control channel. Wireless terminals receiving a special transmission will determine the location of their special transmission based on the starting point for special transmission allocations, a special ordering pattern, and any previous special transmissions. The remaining wireless terminals will determine which blocks are being utilized for special transmissions, and will continue to “fill” the set of shared resource blocks according a normal ordering pattern, while skipping those blocks used for special transmissions.

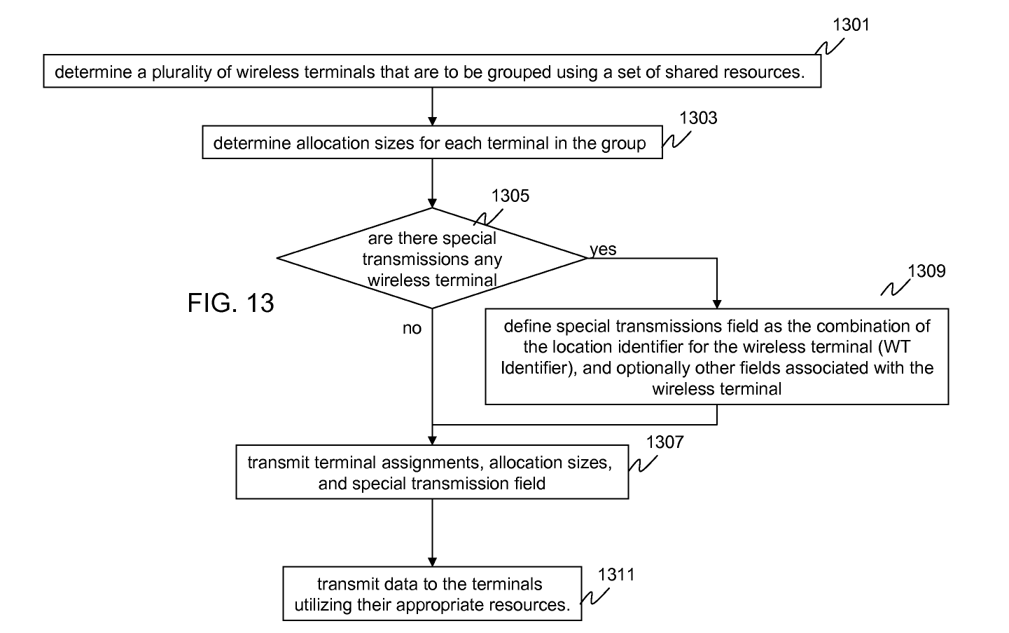

FIG. 13 is a flow chart showing operation of the base station of FIG. 12. The logic flow begins at step 1301 where logic circuitry 1201 (acting as a scheduler) determines a plurality of wireless terminals that are to be grouped using a set of shared resources. As discussed above, all terminals in the group will have a predetermined normal ordering pattern (fill order) for the resources, and a predetermined policy for allocating resources to special transmissions. The special transmissions allocation policy will be transmitted to all wireless terminals as part of a control channel message. In particular, the base station may transmit the group identifier and the special transmissions allocation policy on a control channel. Logic circuitry 1201 then determines allocation sizes for each terminal in the group (step 1303) if more than one allocation size is allowed. If, at step 1305 there is not a need for transmitting special transmissions to any wireless receiver in the group, the logic flow continues to step 1307, otherwise, the logic flow continues to step 1309 where the identifier for the intended wireless terminal (WT identifier) is determined for each wireless terminal requiring a special transmission. Optionally, additional fields are associated with each wireless terminal. For example, any combination of the reserved blocks field, HARQ transmission number field, vocoder rate field, packet data field, and allocated block field may be appended to each WT identifier. The concatenation of the fields for each wireless terminal receiving a special transmission is defined as the special transmissions field. Note that, if the BTS is resource limited, it may choose not to allocate any resources to special transmissions.

At step 1307 control channel circuitry 1205 transmits terminal assignments, allocation sizes, and, if needed, the special transmissions field. Finally, at step 1311, traffic channel circuitry 1203 transmits data to the terminals utilizing their appropriate resources.

FIG. 14 is a block diagram of a terminal. As shown, terminal 102 comprises logic circuitry 1401, traffic channel circuitry 1403, and control channel circuitry 1405. During operation, data is received via either control channel circuitry 1405 (via a control channel) or traffic channel circuitry 1403 (utilizing the appropriate shared resource from a set of shared resources (i.e., time slot(s) and subcarrier(s) within a particular interlace)).

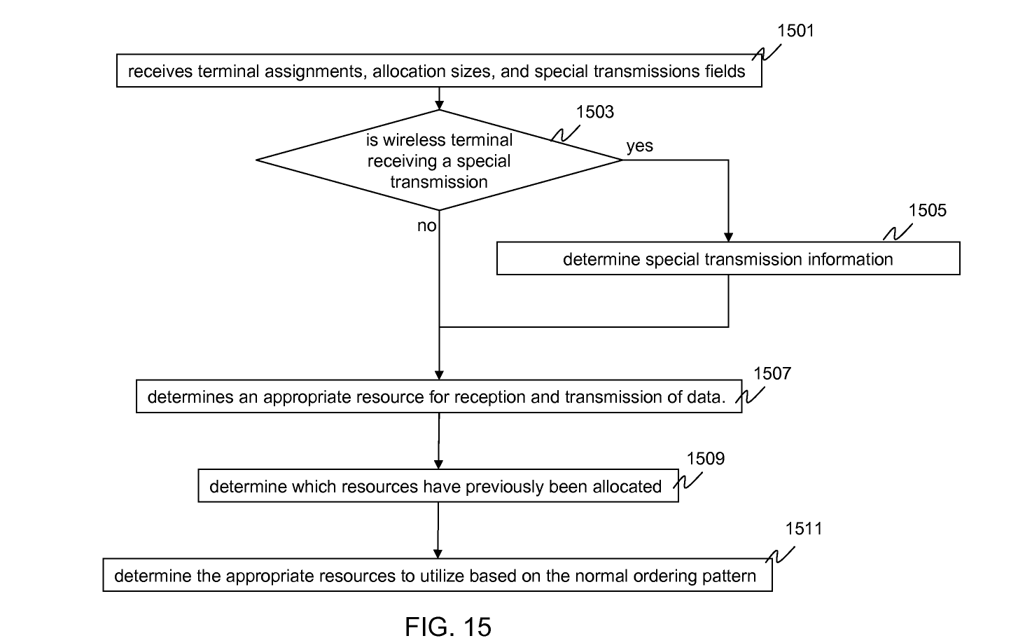

FIG. 15 is a flow chart showing operation of terminal 102. The logic flow begins at step 1501 where control channel circuitry 1405 receives terminal assignments, allocation sizes, and an optional special transmissions field. At step 1503, wireless terminal determines if its identifier is indicated in any one of the special transmission fields. If the wireless terminal does not find its identifier, logic flow continues to step 1507, otherwise, logic flow continues to step 1503, where the wireless terminal determines its special transmission information, which may include any combination of a reserved blocks field, HARQ transmission number field, vocoder rate field, packet data field, and allocated block field. Based on the terminal assignments field, allocation sizes field, and special transmission field, the wireless terminal logic circuitry 1401 determines an appropriate resource for reception and transmission of data 1507. This determination is based on a normal ordering pattern and a special transmission allocation policy, where the special transmission allocation policy contains the beginning block for special transmissions and a special ordering. Logic circuitry 1401 will determine which resources have previously been allocated (step 1509) and utilizing this information and allocation sizes, logic circuitry 1401 will determine the appropriate resources to utilize based on the normal ordering pattern (step 1511).

While the present disclosure and the best modes thereof have been described in a manner establishing possession by the inventors and enabling those of ordinary skill in the art to make and use the same, it will be understood and appreciated that there are many equivalents to the exemplary embodiments disclosed herein and that modifications and variations may be made thereto without departing from the scope and spirit of the inventions, which are to be limited not by the exemplary embodiments but by the appended claims.

What is claimed is:

1. A method in a wireless communication infrastructure entity, the method comprising:
assigning a plurality of schedulable wireless communication entities to a group, wherein each schedulable wireless communication entity is assigned a location within the group, wherein the group is assigned a shared wireless resource, and wherein the group is controlled with a shared control channel;
indicating a terminal assignments field on a shared control channel, the terminal assignments field indicating which of the plurality of schedulable wireless communication entities assigned to the group have been assigned a wireless resource;
indicating at least one special transmissions field on a shared control channel, the special transmissions field specifying the identifier of the wireless terminal for which a special transmission is intended.

2. The method according to claim 1, wherein the at least one special transmissions field is encoded and transmitted separately from the terminal assignments field.

3. The method according to claim 1, wherein the at least one special transmissions field is concatenated to the terminal assignments field, and the concatenated fields are encoded and transmitted together.

4. The method according to claim 1, wherein the special transmissions field also includes a reserved blocks field, the reserved blocks field specifying the number of time-frequency resources that are allocated for the special transmission.

5. The method according to claim 1, wherein the special transmissions field also includes a hybrid automatic repeat request transmission number field, the hybrid automatic repeat request transmission number field specifying the transmission number within a series of hybrid automatic repeat request transmission numbers for which the wireless communication infrastructure entity is allocating resources.

6. The method according to claim 1, wherein the special transmissions field also includes a vocoder rate field, the vocoder rate field specifying the vocoder rate of the voice packet for which the wireless communication infrastructure entity is allocating resources.

7. The method according to claim 1, wherein the special transmissions field also includes a packet data field, the packet data field specifying the presence and packet size of a packet data transmission for the wireless terminal for which a special transmission is intended.

8. The method according to claim 1, wherein the special transmissions field also includes an allocated block field, the allocated block field specifying the beginning resource block for the wireless terminal for which a special transmission is intended.

9. The method according to claim 1, further comprising indicating a special transmission allocation policy, the special transmission allocation policy specifying a beginning resource block within the assigned shared wireless resource for special transmissions and a special ordering pattern for special transmissions.

10. The method according to claim 1, wherein the identifier of the wireless terminal is the wireless terminal's location within the group.

11. The method according to claim 1, wherein the identifier of the wireless terminal is a sector specific identifier unique to the wireless terminal.

12. A method in a schedulable wireless communication entity assigned to a group with a plurality of other schedulable wireless communication entities wherein each schedulable wireless communication entity is assigned a location within the group, wherein the group is assigned a shared wireless resource, and wherein the group is controlled with a shared control channel, the method comprising:
receiving a terminal assignments field on a shared control channel, the terminal assignments field indicating which of the plurality of schedulable wireless communication entities assigned to the group have been assigned a wireless resource;
receiving at least one special transmissions field on a shared control channel, the special transmissions field specifying the identifier of the wireless terminal for which a special transmission is intended.

13. The method according to claim 12, further comprising receiving a special transmission allocation policy, the special transmission allocation policy specifying a beginning resource block within the assigned shared wireless resource for special transmissions and a special ordering pattern for special transmissions.

14. The method according to claim 12, further comprising:
determining if the identifier of the wireless terminal corresponds to one of the identifiers indicated in the at least one special transmissions field;
determining an appropriate resource within the shared wireless resource for reception of data based on wireless terminals allocated in any previous special transmission fields.

15. The method according to claim 12, further comprising determining the number of time-frequency resources that are allocated for the special transmission based on a reserved blocks field which was received as part of the special transmissions field.

16. The method according to claim 12, further comprising determining the transmission number within a series of hybrid automatic repeat request transmission numbers for which the wireless communication infrastructure entity is allocating resources based on a hybrid automatic repeat request transmission number field which was received as part of the special transmissions field.

17. The method according to claim 12, further comprising determining the vocoder rate of the voice packet for which the wireless communication infrastructure entity is allocating resources based on a vocoder rate field which was received as part of the special transmissions field.

18. The method according to claim 12, further comprising determining the presence and packet size of a packet data transmission for the wireless terminal for which a special transmission is intended based on a packet data field which was received as part of the special transmissions field.

19. The method according to claim 12, further comprising determining the beginning resource block for the wireless terminal for which a special transmission is intended based on an allocated block field which was received as part of the special transmissions field.

20. The method according to claim 12, further comprising:
determining if the wireless terminal is indicated as active in the terminal assignments field;
determining which resources were allocated for special transmission;
determining which resources were allocated as part of the terminal assignments field for wireless terminals with a smaller location within the group;
determining the appropriate resource for reception of data as the first available resource within the shared set of resource that was not allocated for special transmissions and was not allocated for wireless terminals with a smaller location within the group.

21. An apparatus comprising:
means for assigning a plurality of schedulable wireless communication entities to a group, wherein each schedulable wireless communication entity is assigned a location within the group, wherein the group is assigned a shared wireless resource, and wherein the group is controlled with a shared control channel;
means for indicating a terminal assignments field on a shared control channel, the terminal assignments field indicating which of the plurality of schedulable wireless communication entities assigned to the group have been assigned a wireless resource;
means for indicating at least one special transmissions field on a shared control channel, the special transmissions field specifying the identifier of the wireless terminal for which a special transmission is intended.

22. An apparatus comprising:
means for receiving a terminal assignments field on a shared control channel, the terminal assignments field indicating which of a plurality of schedulable wireless communication entities assigned to a group have been assigned a wireless resource, wherein a schedulable wireless communication entity is assigned to the group with the plurality of other schedulable wireless communication entities, wherein each schedulable wireless communication entity is assigned a location within the group, wherein the group is assigned a shared wireless resource, and wherein the group is controlled with a shared control channel;
means for receiving at least one special transmissions field on a shared control channel, the special transmissions field specifying the identifier of the wireless terminal for which a special transmission is intended.
